(19) United States
(12) Patent Application Publication
(10) Pub. No.: US 2016/0275967 A1
(43) Pub. Date: Sep. 22, 2016

(54) PRESENTATION SUPPORT APPARATUS AND METHOD

(71) Applicants: KABUSHIKI KAISHA TOSHIBA, Tokyo (JP); TOSHIBA SOLUTIONS CORPORATION, Kawasaki-shi (JP)

(72) Inventors: Kazuo Sumita, Yokohama Kanagawa (JP); Satoshi Kamatani, Kawasaki Kanagawa (JP); Kazuhiko Abe, Tokyo (JP); Kenta Cho, Kawasaki Kanagawa (JP)

(21) Appl. No.: 15/064,987

(22) Filed: Mar. 9, 2016

(30) Foreign Application Priority Data
Mar. 18, 2015 (JP) 2015-055312

(51) Int. Cl. G10L 21/10; G10L 15/26; G10L 13/02; G06F 17/28

(52) U.S. Cl. CPC G10L 21/10; G06F 17/2836; G10L 15/26; G10L 13/02

(57) ABSTRACT

According to one embodiment, a presentation support apparatus includes a switcher, an acquirer, a recognizer and a controller. The switcher switches a first content to a second content in accordance with an instruction of a first user, the first content and the second content being presented to the first user. The acquirer acquires a speech related to the first content from the first user as a first audio signal. The recognizer performs speech recognition on the first audio signal to obtain a speech recognition result. The controller controls continuous output the first content to a second user, when the first content is switched to the second content, during a first period after presenting the speech recognition result to the second user.

### CROSS-REFERENCE TO RELATED APPLICATIONS

This application is based upon and claims the benefit of priority from Japanese Patent Application No. 2015-055312, filed Mar. 18, 2015, the entire contents of which are incorporated herein by reference.

### FIELD

Embodiments described herein relate generally to a presentation support apparatus and method.

### BACKGROUND

To realize a speech translation system targeting speeches at conferences and lectures, etc., it is desirable to consider the timing of outputting a speech recognition result and a machine translation result as a speaker shows slides to audience members while speaking. Processing time is always required for speech recognition and machine translation. Accordingly, if subtitles or synthesized speech audio of a speech recognition result or a machine translation result is output when these results are obtained, the original speech audio of the speaker is usually output with a delay from the actual time of the speech. For this reason, when the speaker shows a next slide, it is possible that the output of subtitles and synthesized speech audio for the content explained in a previous slide may not be finished. It would be an obstacle for audience members' understanding if the audience member synthesized speech audio corresponding to a speech recognition result and a machine translation result,

### BRIEF DESCRIPTION OF THE DRAWINGS

FIG. 1 is a conceptual diagram showing a presentation support apparatus according to the present embodiments.

FIG. 2 is a block diagram showing a presentation support apparatus according to the first embodiment.

FIG. 3 is a drawing showing a correspondence relationship table stored in a correspondence storage according to the first embodiment.

FIG. 4A is a flowchart showing a presentation support process of the speech translation apparatus according to the first embodiment.

FIG. 4B is a flowchart showing a presentation support process of the speech translation apparatus according to the first embodiment.

FIG. 5 is a drawing showing the relationship between a speaker's speech and a display of content and a speech recognition result for the audience members according to the first embodiment.

FIG. 6 is a drawing showing a correspondence relationship table stored in a correspondence storage according to the second embodiment.

FIG. 7A is a flowchart showing a presentation support process of the speech translation apparatus according to the second embodiment.

FIG. 7B is a flowchart showing a presentation support process of the speech translation apparatus according to the second embodiment.

FIG. 8 is a drawing showing the relationship between a speaker's speech and a display of content and a speech recognition result for the audience members according to the second embodiment.

FIG. 9 is a block diagram showing a presentation support apparatus according to the third embodiment.

FIG. 10 is a block diagram showing a presentation support apparatus according to the fourth embodiment.

### DETAILED DESCRIPTION

In general, according to one embodiment, a presentation support apparatus includes a switcher, an acquirer, a recognizer and a controller. The switcher switches a first content to a second content in accordance with an instruction of a first user, the first content and the second content being presented to the first user. The acquirer acquires a speech related to the first content from the first user as a first audio signal. The recognizer performs speech recognition on the first audio signal to obtain a speech recognition result. The controller controls continuous output the first content to a second user, when the first content is switched to the second content, during a first period after presenting the speech recognition result to the second user.

Hereinafter, the presentation support apparatus and method according to the present embodiments will be described in detail with reference to the drawings, in the following embodiments, the elements which perform the same operations will be assigned the same reference symbols, and redundant explanations will be omitted as appropriate.

In the following, the embodiments will be explained on the assumption that a speaker speaks in Japanese; however, a speaker's language is not limited to Japanese. The same process can be performed in a similar manner in a case of a different language.

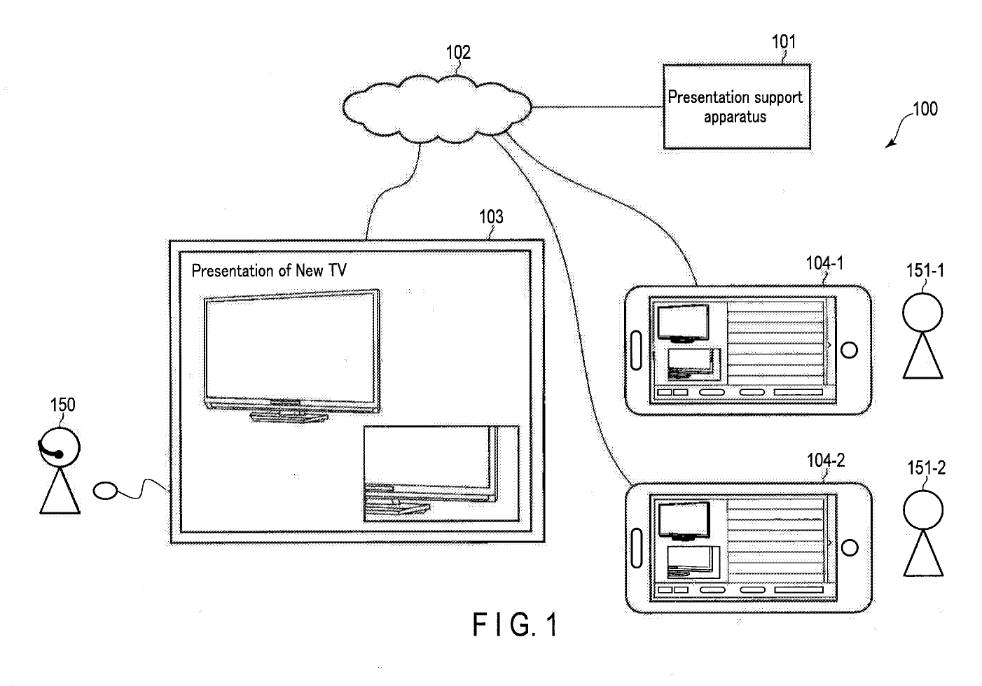

An example of use of the presentation support apparatus according to the present embodiments will be explained with reference to FIG. 1.

FIG. 1 is a conceptual drawing illustrating the presentation support system 100 including a presentation support apparatus. The lecture support system 100 includes a presentation support apparatus 101, a speaker's display 103, and audience member's displays 104-1 and 104-2.

The speaker's display 103 is a display that the speaker 150 (may be referred to as “the first user”) views. The audience member's displays 104-1 and 104-2 are the displays that are viewed by an audience member 151-1 (may be referred to as “the second user”) and 151-2. Herein, assume there are two audience members; however, the number of audience members may be one, three, or more.

The speaker 150 gives a lecture or a presentation, looking at content displayed on the lecture's display 103. The speaker 150 sends instructions to switch the content to the presentation support apparatus 101 via the network 102, using a switch instructing means, such as a mouse and a keyboard, etc., to switch the content displayed on the speaker's display 103.

In the present embodiments, it is assumed that the content is a set of slides divided by pages, such as a set of slides that would be used in a presentation; however, a set of slides may contain animation, or the content may just be a set of images.

The content may be a video of a demonstration of instructions for machine operation, or a video of a system demonstration. If the content is a video, when a scene switches, or when a photography position switches may be regarded as one page of content. In other words, any kind of content can be used as long as the displayed content is switchable.

The audience member 151 can view the content related to the lecture and character information related to a speech recognition result displayed on the audience member's display 104 via the network 102. Displayed content is switched in the audience member's display 104 when new content is received from the presentation support apparatus 101. In the example shown in FIG. 1, the audience member's display 104 is a mobile terminal, such as a smart phone or a tablet; however, it may be a personal computer connected to the residential network 102, for example.

### First Embodiment

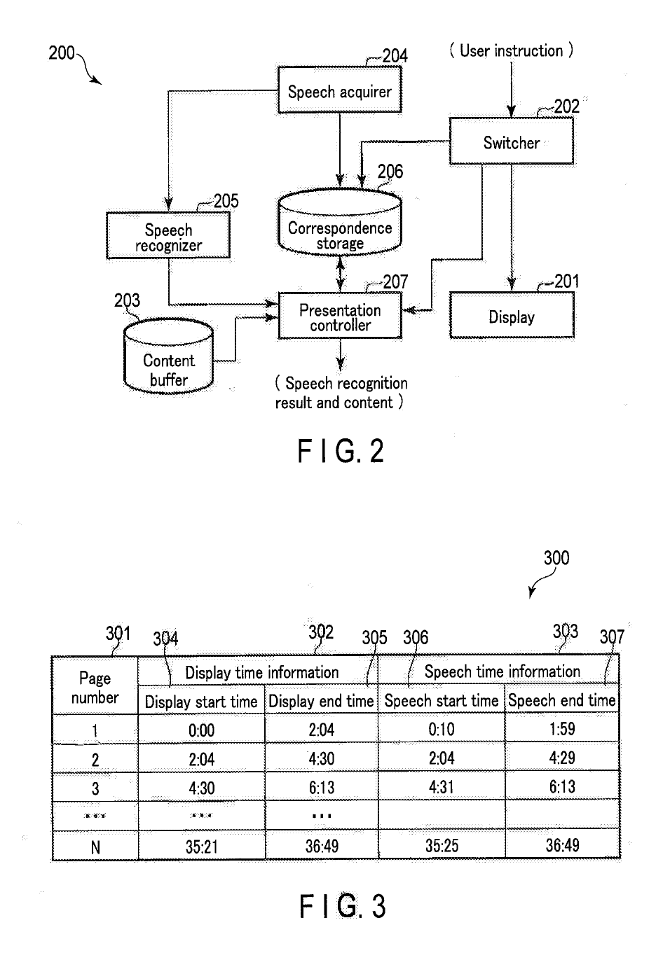

The presentation support apparatus according to the first embodiment will be explained with reference to the block diagram in FIG. 2.

The presentation support apparatus 200 according to the first embodiment includes a display 201, a switcher 202, a content buffer 203, a speech acquirer 204, a speech recognizer 205, a correspondence storage 206, and a presentation controller 207.

The display 201 displays content for the speaker.

The switcher 202 switches the content which is currently displayed on the display 201 to the next content, in accordance with the speaker's instruction. Furthermore, the switcher 202 generates information related to a content display time based on time information at the time of content switching.

The content buffer 203 buffers the content to be displayed to the audience members.

The speech acquirer 204 acquires audio signals of a speech related to the speaker's content. Furthermore, the speech acquirer 204 detects a time of the beginning edge of the audio signal time of the ending edge of the audio signal to acquire information related to a speech time. To detect the beginning and ending edges of an audio signal, a voice activity detection (VAD) method can be adopted, for example. Since a VAD method is a general technique, an explanation is omitted herein.

The speech recognizer 205 receives audio signals from the speech acquirer 204, and sequentially performs speech recognition on the audio signals to obtain a speech recognition result.

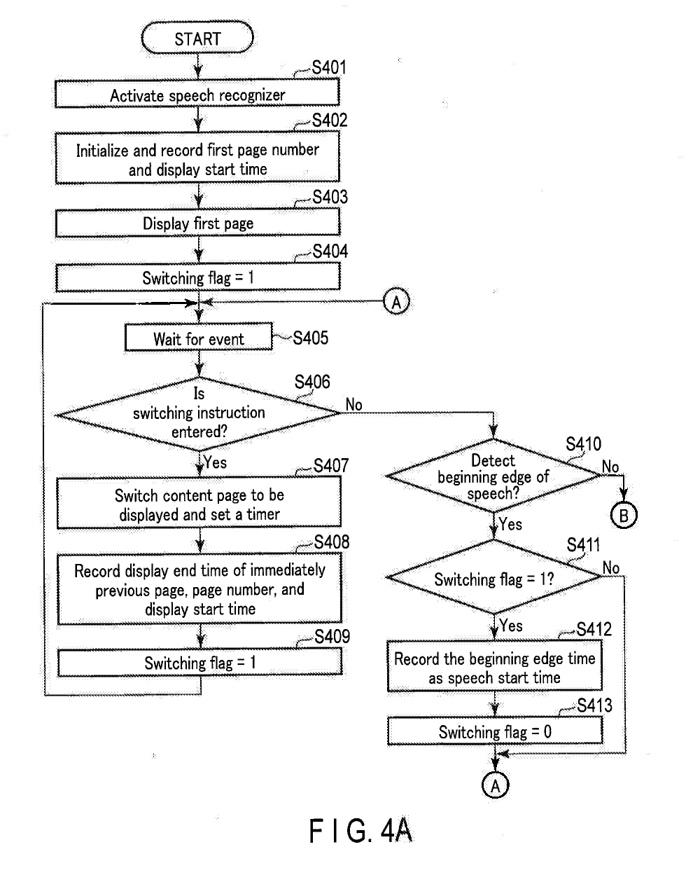

The correspondence storage 206 receives information related to a content display time from the switcher 202, and information related to a speech time from the speech acquirer 204, and stores the received information as a correspondence relationship table indicating a correspondence relationship between the content display time and the speech time. The details of the correspondence relationship table will be described later with reference to FIG. 3.

The presentation controller 207 receives a speech recognition result from the speech recognizer 205 and content from the content buffer 203, and controls the output to present the speech recognition result and the content to be viewable by the audience members. In the example shown in FIG. 1, the speech recognition result and the content are output to be displayed on the audience member's display 104.

The presentation controller 207 receives the speaker's instructions (instructions to switch content) from the switcher 202, and if the content is switched in accordance with the switch instructions, the presentation controller 207 refers to the correspondence relationship table stored in the correspondence storage 206 and controls output of the speech recognition result and the content in such manner that the content before switching is continuously presented to the audience members within a first period of time after a speech recognition result related to the content before switching is presented to the audience members.

Next, an example of the correspondence relationship table stored in the correspondence storage 206 according to the first embodiment is explained with reference to FIG. 3.

The correspondence relationship table 300 shown in FIG. 3 includes a page number 301, display time information 302, and speech time information 303.

The page number 301 is a content page number, and it is a slide number in the case of presentation slides. If the content is a video, a unique ID may be assigned by units where scenes are switched, or where photographing positions are switched.

The display time information 302 indicates the length of time during which the content is being displayed; herein, the display time information 302 is a display start time 304 and a display end time 305. The display start time 304 indicates a time when the display of content corresponding to a page number starts, and the display end time 305 indicates a time when it ends.

The speech time information 303 indicates the length of a speaker's speech time corresponding to the content; herein, the speech time information 303 is a speech start time 306 and a speech end time 307. The speech start time 306 indicates a time when a speech for content corresponding to a page number starts, and the speech end time 307 indicates a time when it ends.

Specifically, for example, the table relates the display start time 304 “0:00”, the display end time 305 “2:04”, the speech start time 306 “0:10”, and the speech end time 307 “1:59” with the page number 301 “1” for record storage. It can be understood from the above information that the display time for the content on page 1 is “2:04”, and the speech time for the same is “1:49”.

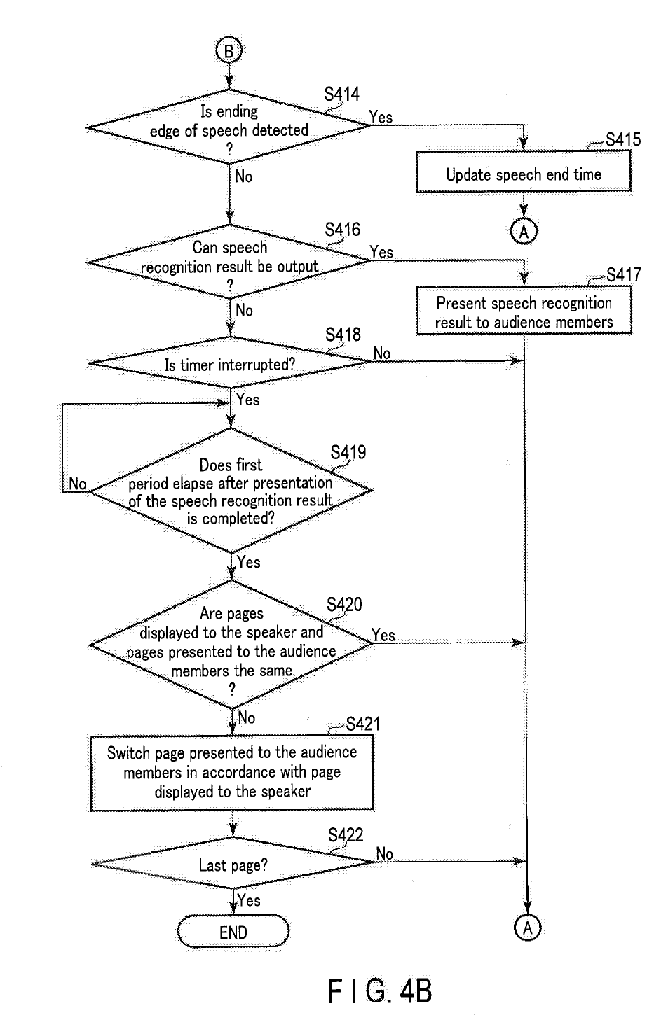

Next, the presentation support process of the presentation support apparatus 200 according to the first embodiment will be described with reference to FIG. 3 and the flowcharts of FIG. 4A and 4B. In the following description, assume that the content is divided by pages.

In step S401, the speech recognizer 205 is activated.

In step S402, the presentation controller 207 initializes data stored in the correspondence storage 206, and stores a page number of the content which is to be presented first and a display start time for the content in the correspondence storage 206. In the example shown in FIG. 3, the page number 301 “1” and the display start time 304 “0:00” are stored in the correspondence storage 206.

In step S403, first content is displayed on the display 201 for the speaker, and the presentation controller 207 controls output of the first content so that the first content will be presented to the audience members. Specifically, in the example shown in FIG. 1, content is output to the audience member's display 104.

In step S404, the presentation controller 207 sets the switching flag to 1. The switching flag indicates whether or not the content is switched.

In step S405, the presentation support apparatus 200 enters an event wait state. The event wait state is a state in which the presentation support apparatus 200 receives inputs such as content switching a speech from the speaker.

In step S406, the switcher 202 determines whether or not a switch instruction is input from the speaker. If a switch instruction is entered, the process proceeds to step S407, and if no switch instruction is entered, the process proceeds to step S410.

In step S407, the switcher 202 switches a page of the content being displayed to the audience members, and sets a timer. The time is set in order to advance the process to step S418 and the steps thereafter, which will be described later; however, a preset time can be used, and a time can be set in accordance with a situation.

In step S408, the switcher 202 stores, in the correspondence storage 206, a display end time corresponding to a page of content displayed before switching, a page number after page switching, and a display start time corresponding to a page of content after switching. In the example shown in FIG. 3, the display end time 305 “2:04” of the content on the page number 301 “1” displayed before switching, the page number 301 “2” after page switching, and the display start time 304 “2:04” of the page number 301 “2” are stored in the correspondence storage 206.

In step S409, the presentation controller 207 sets the switching flag to 1 if the flag is not at 1, and the process returns to the event wait process in step S405.

In step S410, the speech acquirer 204 determines if a beginning edge of the lecture's speech is detected or not If a beginning edge is detected, the process proceeds to step S411; if not, the process proceeds to step S414.

In step S411, the presentation controller 207 determines if the switching flag is 1 or not. If the switching flag is 1, the process proceeds to step S412; if not, the process proceeds to the event wait process in step S405 because the switching flag not being 1 means that a speech start time has already been stored.

In step S412, since the beginning edge belongs to a speech immediately after the page switching, the speech acquirer 204 records the page number and the beginning edge time of the speech as a speech start time after the page switching. In the example shown in FIG. 3, the page number 301 “2” and the speech start time 306 “2:04”, for example, are stored in the correspondence storage 206.

In step S413, the switching flag is set to zero, and the process returns to the event wait process in step S405 By setting the switching flag to zero, only a speech start time of the first speaker's speech is stored as a speech start time.

In step S414, the speech acquirer 204 determines if an ending edge of the lecture's speech is detected or not. If an ending edge is detected, the process proceeds to step S415; if not, the process proceeds to step S416.

In step S415, the speech acquirer 204 has the correspondence storage 206 store a speech end time In the example shown in FIG. 3, the speech end time 307 “4:29” of the page number 301 “2” is stored in the correspondence storage 206.

In step S416, it is determined whether or not the speech recognizer 205 can output a speech recognition result. Specifically, for example, it can be determined whether or not the speech recognizer 205 can output the speech recognition result when a speech recognition process for the audio signal is completed and the speech recognition result is ready to be output. If the speech recognition result can be output, the process proceeds to step S417; if not, the process proceeds to step S418.

In step S417, the presentation controller 207 controls output of the speech recognition result to present the result to the audience members. Specifically, data is sent so that a character string of the speech recognition result is displayed on the audience member's terminal in the form of subtitles or a caption. Then, the process returns to the event wait process in step S405.

In step S418, the presentation controller 207 determines whether or not the time which is set at the timer has elapsed (or, whether or not a timer interrupt occurs). If the set time has elapsed, the process proceeds to step S419; if not, the process returns to the event wait process in step S405.

In step S419, the presentation controller 207 determines whether or not a first period has elapsed after the presentation of the speech recognition result to the audience members is completed. Whether or not the presentation of the speech recognition result to the audience members is completed can be determined if a certain period of time has elapsed after the speech recognition result is output from the presentation controller 207, or can be determined when an ACK is received from an auditor's terminal indicating that the presentation of the speech recognition result is finished.

If the first period has elapsed after the speech recognition result is presented, the process proceeds to step S420; if not, the process repeats step S419. Thus, the content before the switching will be continuously presented to the audience members during the first period. The first period is herein defined as a time difference between a display end time and a speech end time in consideration of a timing for switching a speaker's speech and pages. However, the definition is not limited thereto; a time may be set that allows an audience member to understand the content and text of a speech recognition result after they are displayed to the audience member.

In step S420, the presentation controller 207 determines whether or not a page of content displayed to the speaker and a page of content displayed to the audience members are the same. If the pages are the same, the process returns to the event wait process in step S405. If not the same, the process proceeds to step S421.

In step S421, the presentation controller 207 controls output of a content page in order to switch content pages so that a content page displayed to the speaker and a content page displayed to the audience members are the same. Specifically, the content displayed to the speaker is output to the audience member's terminal.

In step S422, the presentation controller 207 determines whether or not the content page presented to the audience member is a last page. If the page is the last page, the process is finished; if not, the process returns to the event wait process in the step S405. The presentation support process of the presentation support apparatus 200 is completed by the above processing.

It is desirable to operate the processes illustrated in FIGS. 4A and 4B on a different thread, and independently from the process such as speech recognition and machine translation, in order to avoid deadlocking of the processes which is caused when the processes depend on timing when the speech recognition result is ready to be output.

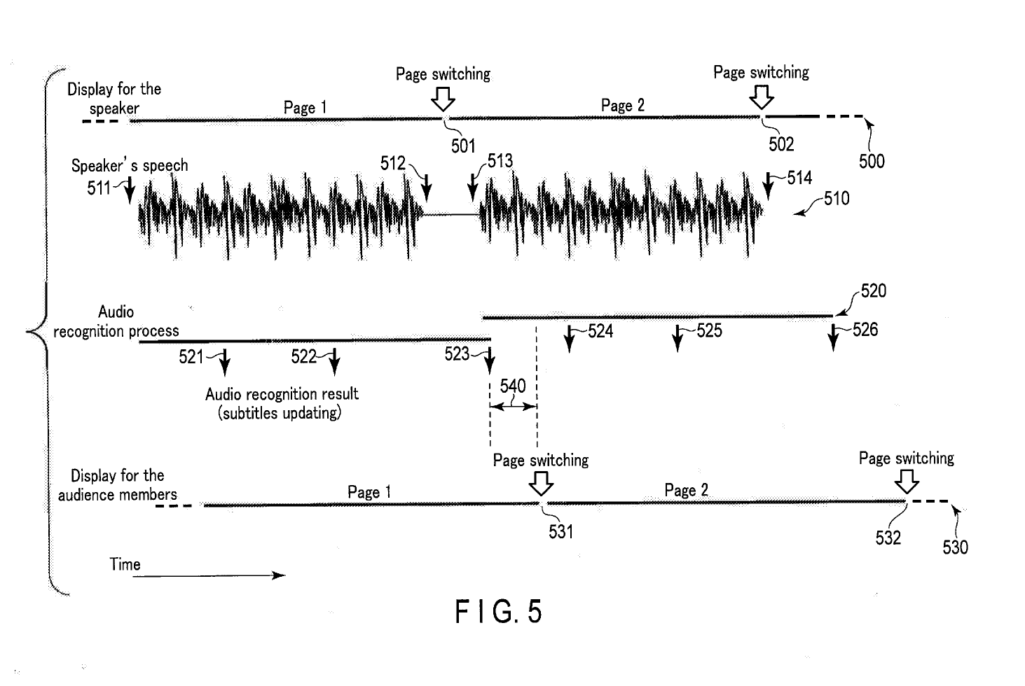

Next, the relationship between the speaker's speech and a display of content for the audience members and a speech recognition result according to the first embodiment is explained with reference to FIG. 5.

FIG. 5 shows time progress of a speaker's speech, a display of the speaker's content, a display of a speech recognition result, and a display of content for the audience members.

The time sequence 500 shows a time sequence related to a display time of content for the speaker, and also indicates switch timing 501 and switch timing 502 when to switch a display of content. In the example shown in FIG. 5, page 1 of content is displayed, and the time sequence shows that the content is switched to page 2 after the switch timing 501. The display start time of page 2 is the switch timing 501, and the display end time of page 2 is the switch timing 502.

The time sequence 510 shows an audio waveform of a speaker's speech in a time series. Herein, the time 511 is a speech start time of page 1, and the time 512 is a speech end time of page 1. The time 513 is a speech start time related to page 2, and the time 514 is a speech end time related to page 2.

The time sequence 520 is a time sequence indicating timing to output a speech recognition result to the audience members with respect to the time sequence 510 of the speaker's speech. In the example shown in FIG. 5, the speech recognition results 521, 522, and 523 are sequentially output with respect to the time sequence of the speaker's speech of page 1 (the speech between the time 511 and the time 512). Similarly, the speech recognition results 524, 525, and 526 are sequentially output with respect to the time sequence of the speaker's speech of page 2 (the speech between the time 513 and the time 514).

The time sequence 530 indicates a time sequence of a display time related to the content for the audience members, and also indicates the switch timing 531 and the switch timing 532.

As shown in FIG. 5, even when the display of the speaker's content is switched from page 1 to page 2, the display of content for the audience members remains on page 1. Then, the first period 540 has elapsed after the speech recognition result 523 is output to the audience members, content on page 1 for the audience members is switched to page 2, and page 2 is displayed. The first period 540 herein is a time difference between the switching 501 and the speech end time 512 when a speech corresponding to page 1 ends.

According to the first embodiment as described above, on the basis of a content display time on the speaker's side and a continuing time of a speech, a content display for the audience members is switched when a first period has elapsed after finishing display of the speech recognition result. Therefore, problems, such as a problem that content switching triggered by switching of the speaker's content before a speech recognition result is displayed, can be solved, and it is possible to maintain a correspondence between the content and a speech recognition result on the audience members' side, thereby facilitating the audience members' understanding of the lecture. In other words, since the audience members can see subtitles along with the content, it becomes easier for them to understand the lecture.

### Second Embodiment

In the first embodiment, a case where the content is divided by pages, and one page corresponds to one speech is described. In the second embodiment, a case where a speaker switches pages while continuing his speech, i.e., a case where a speaker's speech extends over two pages, will be described.

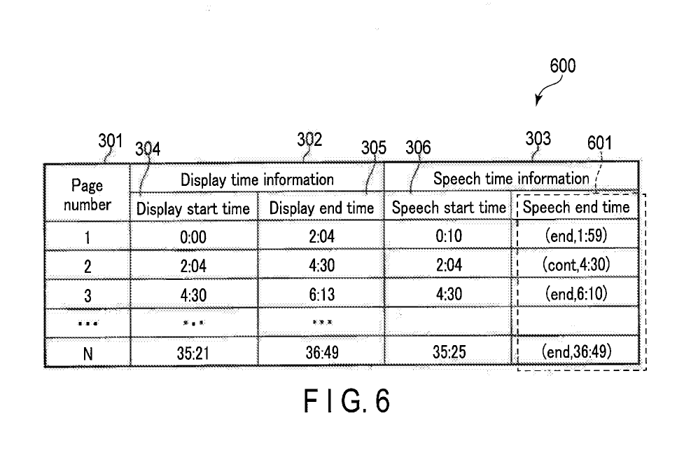

FIG. 6 shows a correspondence relationship table stored in the correspondence storage 206 according to the second embodiment.

The correspondence relationship table 600 shown in FIG. 6 is almost the same as the correspondence relationship table 300 shown in FIG. 3, except for the data recorded as the speech end time 601.

In the speech end time 601 of the table, “end”, indicating that the speech is ended and a speech end time, are recorded, if a speech is completed at the time of page switching. On the other hand, “cont”, indicating that the speech is continuing and a display end time 305, are recorded if a speech is continuing at the time of page switching.

Specifically, in the example shown in FIG. 6, if a speech is ended at the time of page switching, the speech end time 601 “(end, 1:59)” is recorded, and if a speech is continuing at the time of page switching, the speech end time 601 “(cont, 4:30)” is recorded.

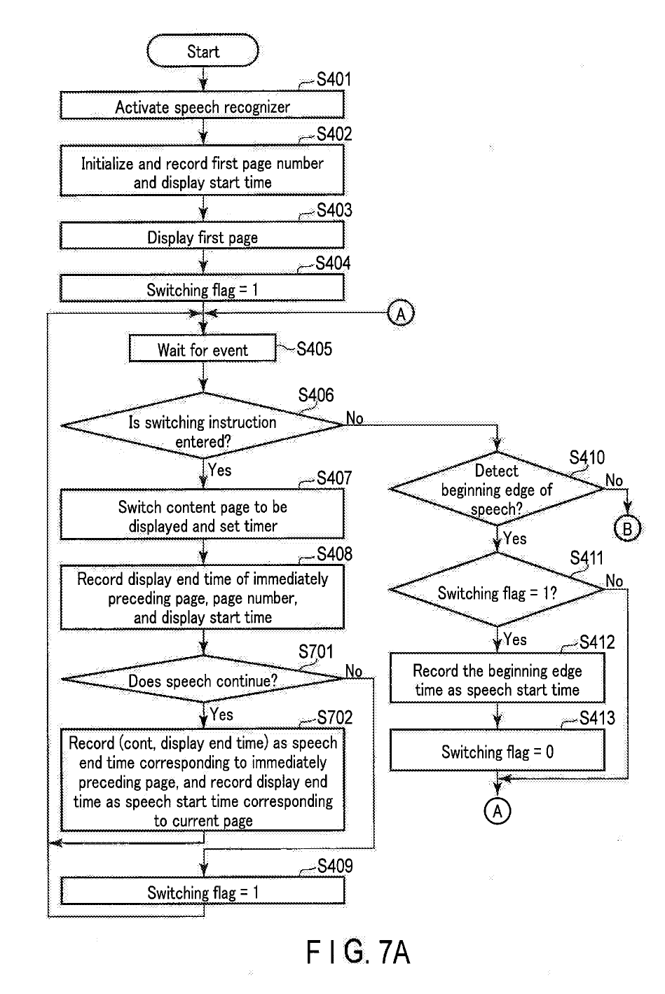

Next, the presentation support process of the presentation support apparatus according to the second embodiment is explained with reference to the flowcharts of FIGS. 7A and 7B.

Since the process is the same as that shown in the flowcharts of FIGS. 7A and 7B, except for steps S701 to S707, descriptions thereof will be omitted.

In step S701, the presentation controller 207 determines if a speaker's speech is continuing or not at the time of page switching. If the speaker's speech is continuing, the process proceeds to step S702; if the speaker's speech is not continuing, in other words, the speaker's speech is completed at the time of page switching, the process proceeds to step S409.

In step S702, the switcher 202 records “(cont, display end time)” as a speech end time corresponding to a page before switching, and records a display end time as a speech start time corresponding to a current page.

In step S703, the speech acquirer 204 records “(end, ending edge time of speech)” as a speech end time in the correspondence storage 206.

In step S704, the presentation controller 207 determines if the speech end time corresponding to a currently-displayed page is (end, T), or (cont, T). Herein, T represents a time; T in (end, T) represents an ending edge of the speech, and T in (cont, T) represents a display end time If the speech end time is (end, T), the process proceeds to step S419, and if the speech end time is (cont, T), the step process proceeds to S706.

In step S705, the presentation controller 207 determines whether or not a second period elapses after the presentation of a speech recognition result to the audience members is completed. If the second period elapses, the process proceeds to step S420; if not, the process repeats the process of step S705 until the second period elapses. Since the speaker's speech herein extends over two pages, it is desirable to set the second period shorter than the first period in order to allow quick page switching; however, the length of the second period may be the same as that of the first period.

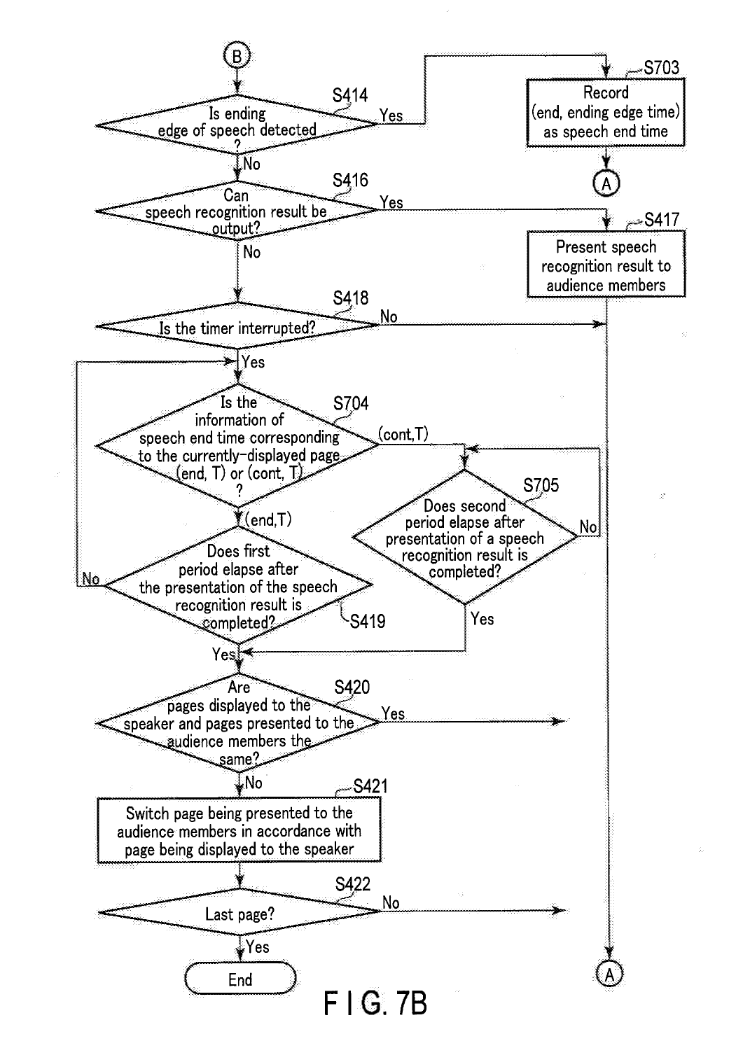

Next, the relationship between the speaker's speech and a display of content for the audience members and a speech recognition result according to the second embodiment is explained with reference to FIG. 8.

FIG. 8 is almost the same as FIG. 5, except that the speaker's speech is continuing at the time of page switching as shown in the time sequence 510.

The presentation controller 207 controls page switching so that page 1 of content that the audience member is viewing is switched to page 2 when the second period 803 has elapsed after the speech recognition result 802 including the speech at the time 801 is output to the audience member (this is the page switching 804 in FIG. 8).

If the speaker's speech is continuing at the time of page switching, the presentation controller 207 controls the output of content to carry out page switching using a so-called fadeout and fade-in after the presentation of the speech recognition result to the audience members is completed.

According to the second embodiment as described above, a correspondence relationship table is generated in accordance with whether or not a speech is continuing at the time of page switching to perform the presentation control referring to the correspondence relationship table; thus, it is possible, like the first embodiment, to maintain a correspondence between the content and a speech recognition result on the audience members' side, thereby facilitating the audience members' understanding of the lecture, even when the speaker switches pages while continuing speaking.

### Third Embodiment

The third embodiment is different from the above-described embodiments with respect to presenting a machine translation result corresponding to a speaker's speech to the audience members.

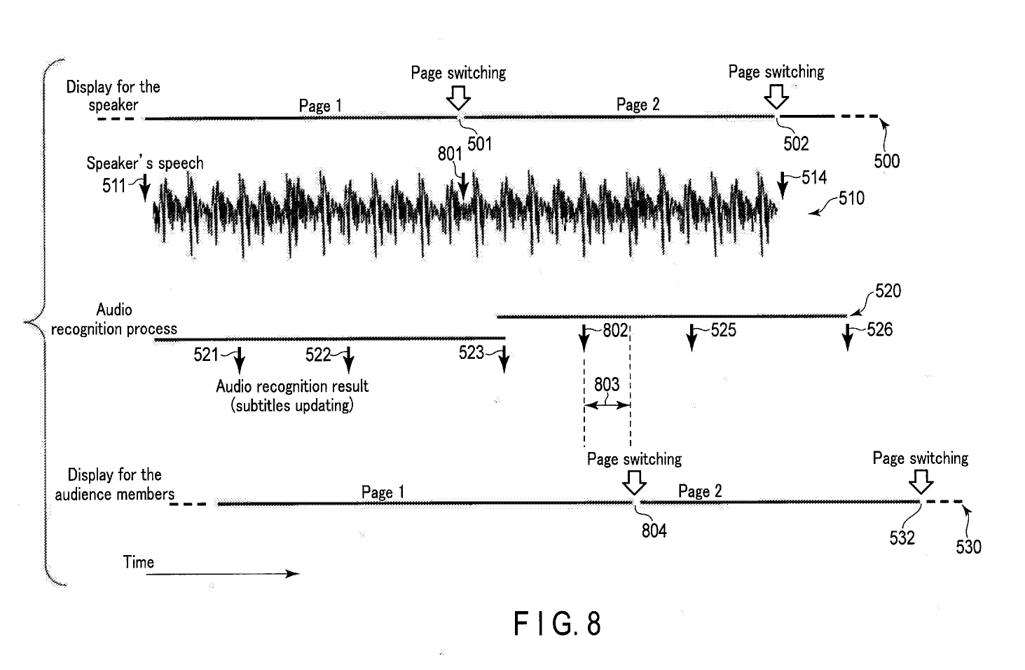

The presentation support apparatus according to the third embodiment will be explained with reference to the block diagram shown in FIG. 9.

The presentation support apparatus 900 according to the third embodiment includes a display 201, a switcher 202, a content buffer 203, a speech acquirer 204, a speech recognizer 205, a correspondence storage 206, a presentation controller 207, and a machine translator 901.

The operation of the presentation support apparatus 900 is the same as that shown in FIG. 2, except for the presentation controller 207 and the machine translator 901; thus, descriptions of the same operation will be omitted.

The machine translator 901 receives the speech recognition result from the speech recognizer 205, and machine-translates the speech recognition result to obtain a machine translation result.

The presentation controller 207 performs the same operation as the operations described in the above embodiments, except that the presentation controller 207 receives a machine translation result from the machine translator 901 and controls the output so that the machine translation result is presented to the audience members. Both of the speech recognition result and the machine translation result may be presented.

According to the third embodiment as described above, a speech recognition result is machine translated where translation from a language of the speaker to a language of the audience members is necessary so that the audience members can understand the lecture despite the speaker's language, thereby facilitating the audience members' understanding of the lecture, like the first embodiment.

### Fourth Embodiment

The fourth embodiment is different from the above-described embodiments with respect to presenting a synthesized speech based on a machine translation result of a speaker's speech.

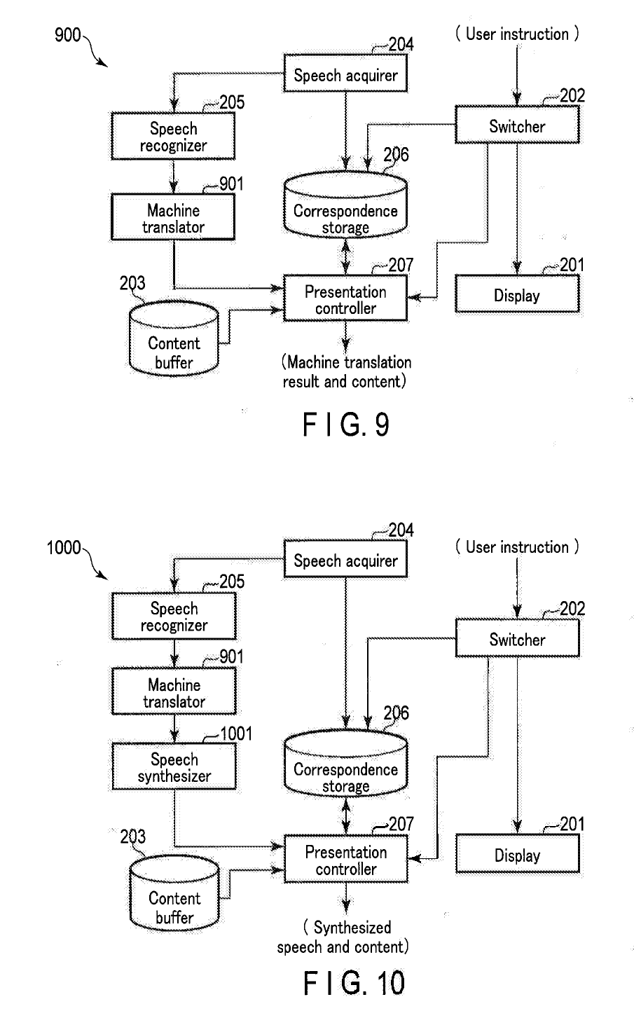

The presentation support apparatus according to the fourth embodiment will be explained with reference to the block diagram shown in FIG. 10.

The presentation support apparatus 1000 according to the fourth embodiment includes a display 201, a switcher 202, a content buffer 203, a speech acquirer 204, a speech recognizer 205, a correspondence storage 206, a presentation controller 207, a machine translator 901, and a speech synthesizer 1001.

The operation of the presentation support apparatus 1000 is the same as that shown in FIG. 2, except for the presentation controller 207 and the speech synthesizer 1001; thus, descriptions of the same operation will be omitted.

The speech synthesizer 1001 receives a machine translation result from the machine translator 901, and performs speech synthesis on the machine translation result to obtain a synthesized speech.

The presentation controller 207 performs almost the same operation as the above-described embodiments, except that the presentation controller 207 receives a synthesized speech from the speech synthesizer 1001 and controls output so that the synthesized speech is presented to the audience members. The presentation controller 207 may control the output so that the speech recognition result, the machine translation result, and the synthesized speech are presented to the audience members, or the machine translation result and the synthesized speech are presented to the audience members.

According to the fourth embodiment as described above, a synthesized speech can be output to the audience member, thereby facilitating the audience members' understanding of the lecture, like the first embodiment.

The flow charts of the embodiments illustrate methods and systems according to the embodiments. It is to be understood that the embodiments described herein can be implemented by hardware, circuitry, software, firmware, middleware, microcode, or any combination thereof. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions

What is claimed is:

1. A presentation support apparatus, comprising:
a switcher that switches a first content to a second content in accordance with an instruction of a first user, the first content and the second content being presented to the first user;
an acquirer that acquires a speech related to the first content from the first user as a first audio signal;
a recognizer that performs speech recognition on the first audio signal to obtain a speech recognition result; and
a controller that controls continuous output of the first content to a second user, when the first content is switched to the second content, during a first period after presenting the speech recognition result to the second user.

2. The apparatus according to claim 1, wherein the controller controls the output so that the second content is presented to the second user after the first period elapses.

3. The apparatus according to claim 1, further comprising a storage that stores a speech start time related to the first audio signal, a speech end time related to the first audio signal, a display start time of the first content and a display end time of the first content which are associated with each other,
wherein the first period is a time difference between the display end time and the speech end time.

4. The apparatus according to claim 3, wherein the storage stores a display end time of the first content as the speech end time if the first user is continuing a speech when switching the first content to the second content, and
the controller controls the output so that the second content is presented to the second user after a second period elapses.

5. The apparatus according to claim 1, further comprising a display that displays the first content and the second content to the first user.

6. The apparatus according to claim 1, wherein the speech recognition result is a character string of a speech recognition result related to the first audio signal.

7. The apparatus according to claim 1, further comprising a machine translator that performs machine translation on the speech recognition result to obtain a machine translation result, wherein
if the machine translation result is obtained, the controller controls the continuous output the first content to the second user, when the first content is switched to the second content, during the first period after presenting the machine translation result to the second user.

8. The apparatus according to claim 7, further comprising a synthesizer that performs speech synthesis on the machine translation result to obtain a synthesized speech, wherein
if the synthesized speech is obtained, the controller controls the continuous output the first content to the second user, when the first content is switched to the second content, during the first period after presenting the synthesized speech to the second user.

9. A presentation support method, comprising:
switching a first content to a second content in accordance with an instruction of a first user, the first content and the second content being presented to the first user;
acquiring a speech related to the first content from the first user as a first audio signal;
performing speech recognition on the first audio signal to obtain a speech recognition result; and
controlling continuous output the first content to a second user, when the first content is switched to the second content, during a first period after presenting the speech recognition result to the second user.

10. The method according to claim 9, wherein the controlling controls the output so that the second content is presented to the second user after the first period elapses.

11. The method according to claim 9, further comprising storing, in a storage, a speech start time related to the first audio signal, a speech end time related to the first audio signal, a display start time of the first content and a display end time of the first content which are associated with each other,
wherein the first period is a time difference between the display end time and the speech end time.

12. The method according to claim 11, wherein the storing in the storage stores a display end time of the first content as the speech end time if the first user is continuing a speech when switching the first content to the second content, and
the controlling controls the output so that the second content is presented to the second user after a second period elapses.

13. The method according to claim 9, further comprising displaying the first content and the second content to the first user.

14. The method according to claim 9, wherein the speech recognition result is a character string of a speech recognition result related to the first audio signal.

15. The method according to claim 9, further comprising performing machine translation on the speech recognition result to obtain a machine translation result, wherein
if the machine translation result is obtained, the controlling controls the continuous output the first content to the second user, when the first content is switched to the second content, during the first period after presenting the machine translation result to the second user.

16. The method according to claim 15, further comprising performing speech synthesis on the machine translation result to obtain a synthesized speech, wherein
if the synthesized speech is obtained, the controller controls the continuous output the first content to the second user, when the first content is switched to the second content, during the first period after presenting the synthesized speech to the second user.

17. A non-transitory computer readable medium including computer executable instructions, wherein the instructions, when executed by a processor, cause the processor to perform a method comprising:
switching a first content to a second content in accordance with an instruction of a first user;
acquiring a speech related to the first content from the first user as a first audio signal;
performing speech recognition on the first audio signal to obtain a speech recognition result; and
controlling continuous output the first content to a second user, when the first content is switched to the second content, during a first period after presenting the speech recognition result to the second user.
